(19) United States
(12) Patent Application Publication
(10) Pub. No.: US 2016/0162760 A1
(43) Pub. Date: Jun. 9, 2016

(54) DEVICES, SYSTEMS, AND METHODS FOR LEARNING AND IDENTIFYING VISUAL FEATURES OF MATERIALS

(71) Applicant: CANON KABUSHIKI KAISHA, Tokyo (JP)

(72) Inventors: Sandra Skaff, Mountain View, CA (US); Chao Liu, Pittsburgh, PA (US)

(21) Appl. No.: 14/563,818

(22) Filed: Dec. 8, 2014

(51) Int. Cl. G06K 9/66; G01N 21/47; G06K 9/62

(52) U.S. Cl. CPC G06K 9/66; G06K 9/6269; G06K 9/6256; G06K 9/6264; G01N 21/4738

(57) ABSTRACT

Devices, systems, and methods for classifying materials in a scene obtain spectral-BRDF material samples; learn feature-vector representations for the spectral-BRDF material samples based on the obtained spectral-BRDF material samples; train classifiers using the learned feature-vector representations; and generate a material classification using the trained classifiers and a new material sample.

### BACKGROUND

1. Technical Field

This description generally relates to the acquisition of material features.

2. Background

The angular dependency and wavelength dependency of incident light that is reflected by the surface of a material are described by the spectral bidirectional reflectance distribution function (BRDF). An extension of the BRDF for modeling the appearance of non-uniform surfaces is given by the bidirectional texture function (BTF), which describes non-local scattering effects such as inter-reflections, subsurface scattering, and shadowing.

### SUMMARY

In one embodiment, a method comprises obtaining spectral-BRDF material samples, learning feature-vector representations for the spectral-BRDF material samples based on the obtained spectral-BRDF material samples, training classifiers using the learned feature-vector representations, and generating a material classification using the trained classifiers and a new material sample.

In one embodiment, a system comprises one or more computer-readable media; and one or more processors that are coupled to the computer-readable media and that are configured to cause the system to obtain material samples, wherein the material samples include training samples and one or more test samples; learn feature-vector representations of the training samples based on the obtained training samples; and generate a material classification based on the feature-vector representations of the training samples and on the one or more test samples.

In one embodiment, one or more computer-readable media store instructions that, when executed by one or more computing devices, cause the computing devices to perform operations comprising obtaining material samples, wherein the material samples include training samples and one or more test samples; learning feature-vector representations of the training samples based on the obtained training samples; and generating a material classification based on the feature-vector representations of the training samples and on the one or more test samples.

### BRIEF DESCRIPTION OF THE DRAWINGS

FIG. 1 illustrates an example embodiment of a system for learning and identifying visual features of materials.

FIG. 2 illustrates an example embodiment of an operational flow for classifying materials.

FIG. 3 illustrates examples of images of a material.

FIG. 4 illustrates an example embodiment of visual features and an example embodiment of a neural network.

FIG. 5 illustrates an example embodiment of a system for learning and identifying visual features of materials.

FIG. 6 illustrates an example embodiment of an operational flow for learning and identifying visual features of materials.

FIG. 7 illustrates an example embodiment of a system for learning and identifying visual features of materials.

FIG. 8 illustrates an example embodiment of an operational flow for learning and identifying visual features of materials.

FIG. 9 illustrates an example embodiment of an operational flow for learning and identifying visual features of materials.

FIG. 10 illustrates an example embodiment of a system for learning and identifying visual features of materials.

### DESCRIPTION

The following description presents certain explanatory embodiments. Other embodiments may include alternatives, equivalents, and modifications. Additionally, the explanatory embodiments may include several novel features, and a particular feature may not be essential to some embodiments of the devices, systems, and methods that are described herein.

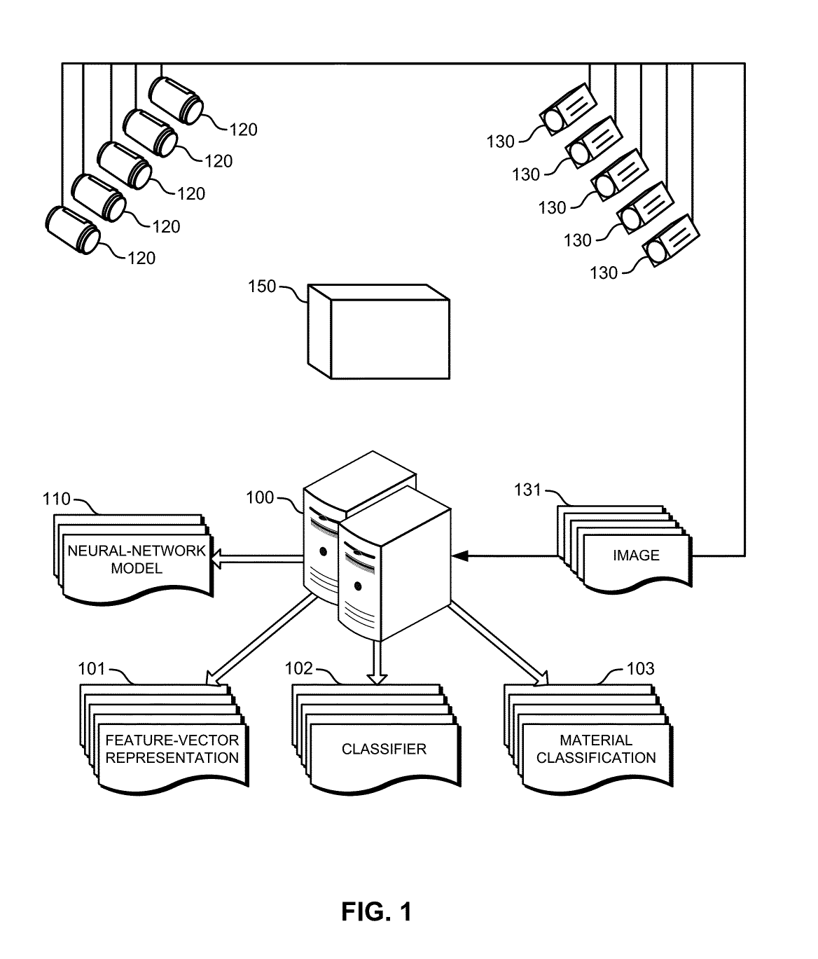

FIG. 1 illustrates an example embodiment of a system for learning and identifying visual features of materials. The system includes one or more material-classification devices 100, one or more illumination-emission devices 120, and one or more illumination-detection devices 130. The illumination-emission devices 120 emit light that is reflected by an object 150, and the reflected light is detected by one or more of the illumination-detection devices 130. The illumination-detection devices 130 send captured images 131 or other illumination-indicating signals to the one or more material-classification devices 100. Based on the images 131 or the other illumination-indicating signals, the one or more material-classification devices 100 generate a feature-vector representation 101 for the materials of the object. The one or more material-classification devices 100 also generate a neural-network model 110 (e.g., a reduced-Boltzmann machine model, a deep neural network) and generate (e.g., train) classifiers 102 based on the feature-vector representations 101 of known materials. Additionally, the one or more material-classification devices 100 generate material classifications 103 for unknown materials based on feature-vector representations 101 that are generated based on images 131 of the unknown materials and on the one or more classifiers 102. A material classification 103 identifies the material or the material category (e.g., metal, fabric, plastic) of an object. Moreover, some embodiments classify sub-categories (e.g., wool, cloth, aluminum alloy, steel) of materials after classifying their categories.

A material-classification device 100 includes a computing device, for example, a desktop computer, a laptop computer, a tablet computer, a smartphone, a server, and a personal digital assistant. An illumination-emission device 120 emits lights and may be, for example, a laser or an LED. Also, an illumination-emission device 120 may be tunable (e.g., a tunable laser, a tunable LED) or may be used with a tunable filter, either of which allows the spectrum of light that is emitted by the illumination-emission device 120 to be adjusted. Additionally, an illumination-emission device 120 may have other configurable settings, for example the polarization of emitted light, the filter (e.g., neutral density filters) that the device uses, the intensity of emitted light, and the orientation of the device (when the device is coupled to a movable mount and a motor).

An illumination-detection device 130 detects light and may be, for example, a camera (e.g., an RGB camera, a light-field camera) or a photometer. An illumination-detection device 130 may include a tunable sensor or a tunable filter, either of which allows the spectrum of light that is detected by the illumination-detection device 130 to be adjusted. Also, an illumination-detection device 130 may have other configurable settings, for example dynamic range, shutter speed, aperture, signal gain (ISO), polarization, the filter used by the device, focal plane, and orientation (when the device is coupled to a movable mount and a motor). An illumination-detection device 130 generates one or more images 131 or other illumination-indicating signals based on the light that it detects.

The images 131 may include a BRDF-image stack, a hyperspectral-image stack (e.g., a hyperspectral data cube), or a combined BRDF-hyperspectral-image stack. Also, an image slice refers to one image in an image stack. And an image patch refers to a subset of an image that extends across the image stack. Furthermore, depending on the embodiment, a sample can be an entire image, an image stack, an image slice, or an image patch. Therefore, a material sample can be an entire image of a material, an image stack of a material, an image slice of a material, or an image patch of a material.

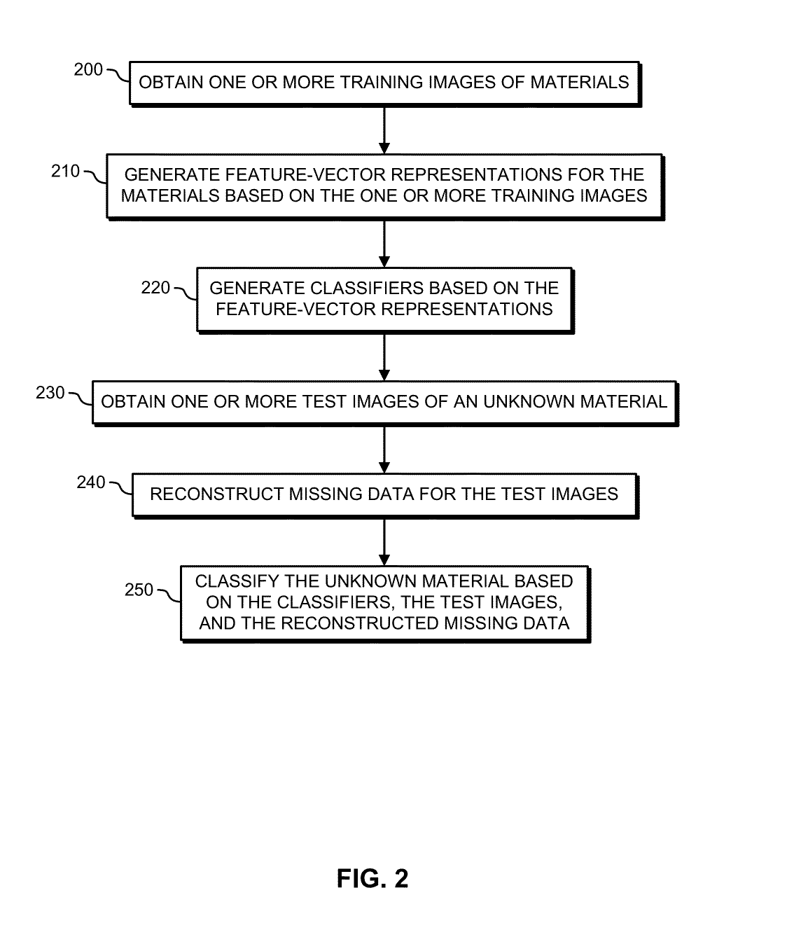

FIG. 2 illustrates an example embodiment of an operational flow for classifying materials. The blocks of this operational flow and the other operational flows that are described herein may be performed by one or more computing devices, for example the computing devices described herein. Also, although this operational flow and the other operational flows that are described herein are each presented in a certain order, some embodiments may perform at least some of the operations in different orders than the presented orders. Examples of different orderings include concurrent, overlapping, reordered, simultaneous, incremental, and interleaved orderings. Thus, other embodiments of this operational flow and the other operational flows that are described herein may omit blocks, add blocks, change the order of the blocks, combine blocks, or divide blocks into more blocks.

The flow starts in block 200, where one or more training images of materials are obtained. Next, in block 210, feature-vector representations are generated for the materials based on the one or more training images, for example based on image slices or image patches from the training images. Block 210 includes generating a neural-network model (e.g., a reduced-Boltzmann-machine model), which includes hidden-layer units and neural-network-model parameters, based on the training images (e.g., on image slices, on image patches). The flow then moves to block 220, where classifiers are generated based on the feature-vector representations. Then, in block 230, one or more test images of an unknown material are obtained.

Next, in block 240, missing data for the test images is reconstructed based on the neural-network model. For example, in an industrial setting, illumination-emission devices and illumination-detection devices can malfunction. Furthermore, even if a malfunction is detected immediately, repairing the malfunction may require several minutes. During this time, the process in a factory, for example, may continue to run because halting an entire process for a small malfunction is not always practical. Thus, in a setting that includes a large number of illumination-detection systems and imaging setups, ensuring that the system is constantly running can be crucial.

And if a part of the system malfunctions, for example if one or more illumination-emission devices fail, then the corresponding images (or, in some embodiments, image slices) may be dark. Consequently, the feature vectors calculated for those images may be meaningless. Additionally, the images (or image slices) could be confused with dark spectral images (or image slices), which could arise when a material is not responsive to a specific wavelength of light. Therefore, some images (or image slices) may be dark even when all of the components of the system are functioning properly.

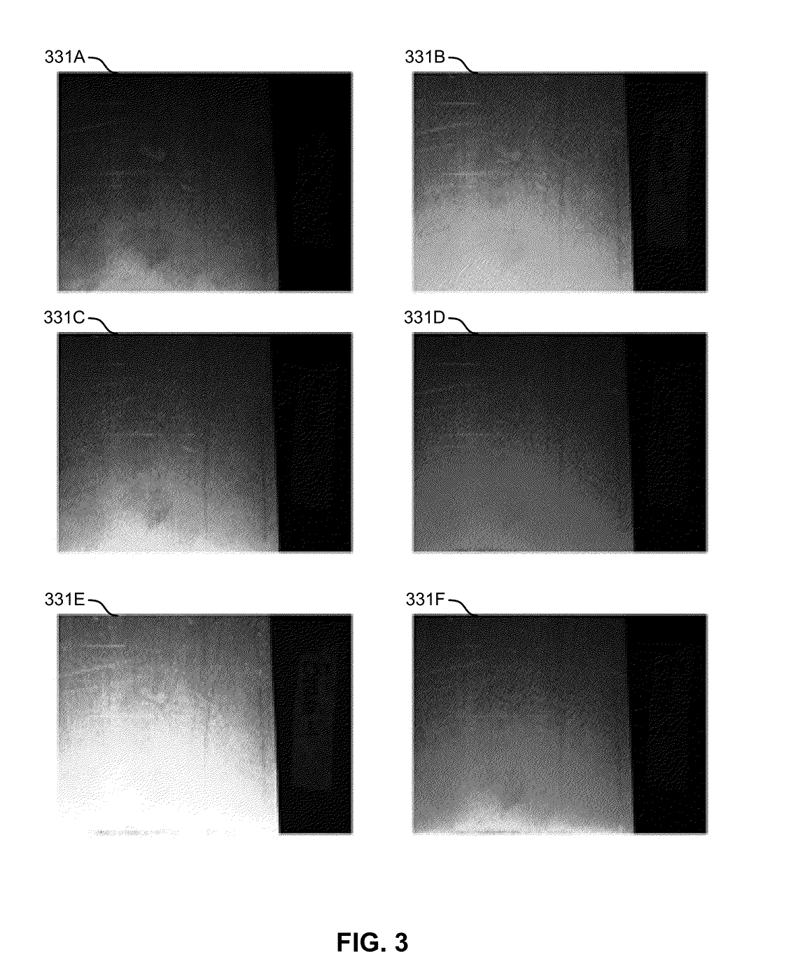

An illustration is shown in FIG. 3, which illustrates examples of images of a material. In this example, the material is brass. Also, in embodiments that use an image stack, each of the images 331A-F may illustrate an image slice. The first image 331A shows the light from a blue LED that was reflected by the brass. The second image 331B shows the light from a green LED that was reflected by the brass. The third image 331C shows the light from a yellow LED that was reflected by the brass. The fourth image 331D shows the light from a red LED that was reflected by the brass. The fifth image 331E shows the light from a white LED that was reflected by the brass. Finally, the sixth image 331F shows the light from an orange LED that was reflected by the brass. Note that the fourth image 331D, which was captured using the red LED, is almost dark, although the red LED and the illumination-detection system were fully functional. Also for example, in FIG. 3 the fifth image 331E, which was captured while the white LED was functional, has a large number of specular and diffuse pixels. However, if the white LED had been broken, then the fifth image 331E would be completely dark.

Therefore, referring again to FIG. 2, to help correct these errors, in block 240 missing data is reconstructed for the test images based on the neural-network model. Finally, in block 250, the unknown material is classified based on the classifiers, the test images, and the reconstructed missing data. For example, some embodiments classify the unknown material based on the classifiers and on feature-vector representations that are generated based on the test image and on the reconstructed missing data.

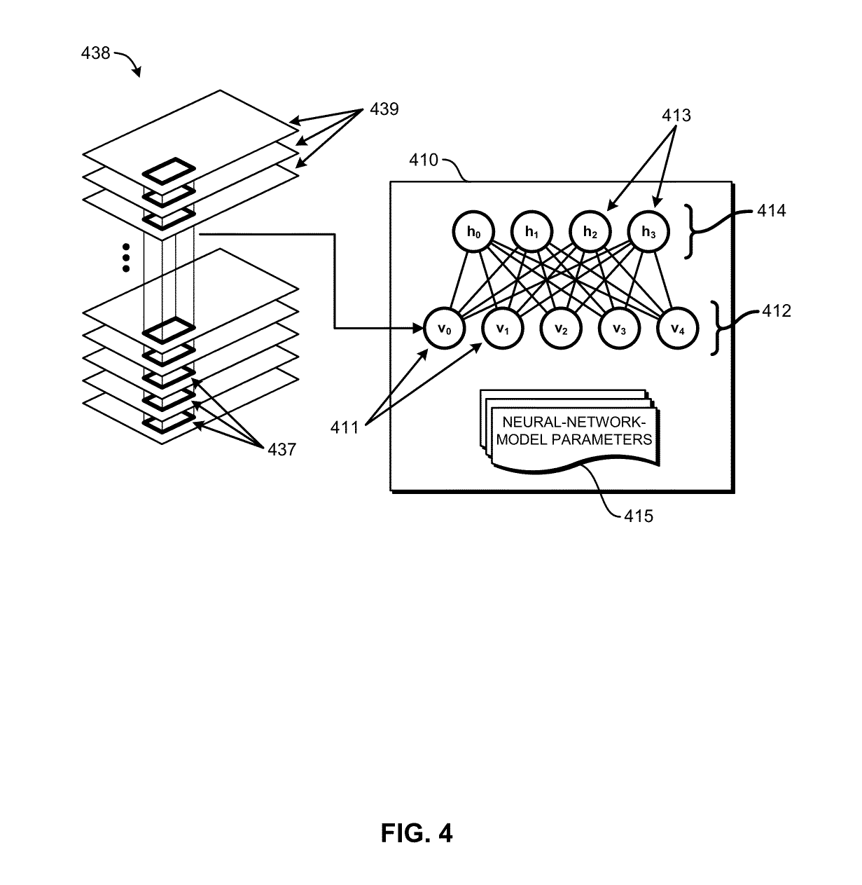

FIG. 4 illustrates an example embodiment of visual features and an example embodiment of a neural network. FIG. 4 shows a pictorial representation of an image stack 438 of a material, and the image stack 438 includes a plurality of image slices 439. Image patches 437 are extracted across the whole stack 438 and are vectorized. The vectorized patches are each used as a visible-layer unit 411 of a visible layer 412 of a neural-network model 410. The hidden-layer units 413 of a hidden layer 414 and the neural-network-model parameters 415 are then generated based on the visible-layer units 411. These neural-network-model parameters 415 include weights that connect the hidden-layer units 413 and the visible-layer units 411 and include offsets of the visible layer 412 and the hidden layer 414. In some embodiments, the number of patches 437 is selected at random.

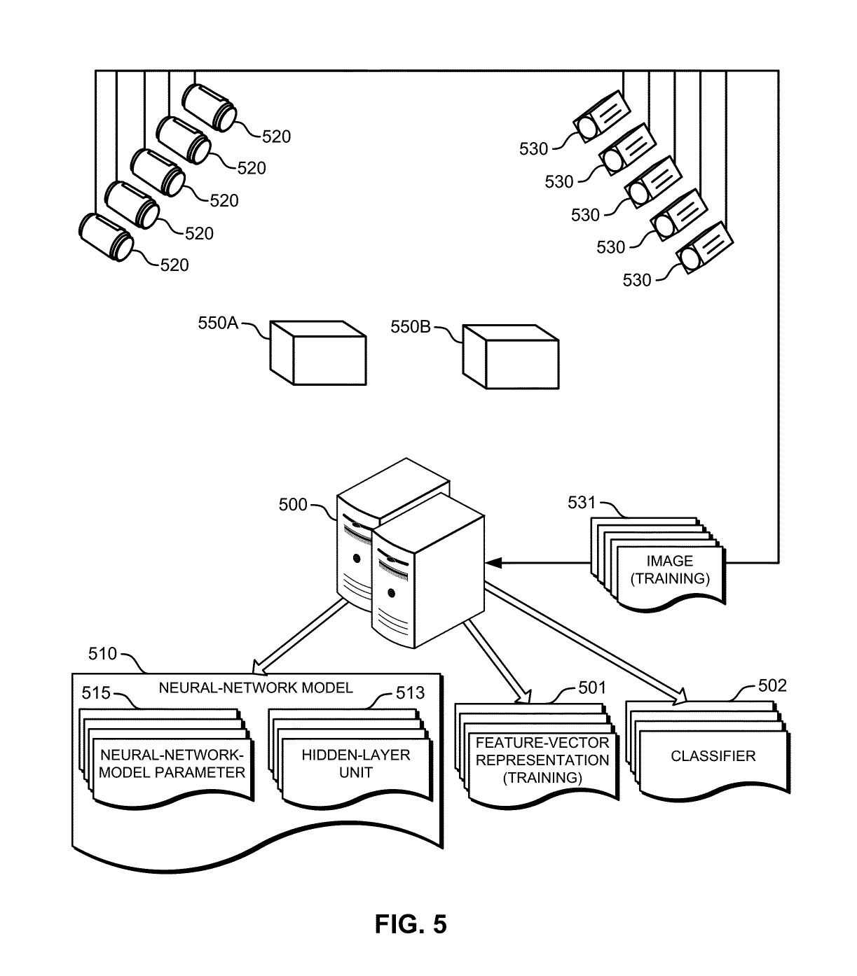

FIG. 5 illustrates an example embodiment of a system for learning and identifying visual features of materials. The system includes one or more material-classification devices 500, one or more illumination-emission devices 520, and one or more illumination-detection devices 530. The illumination-emission devices 520 emit light that is reflected by one or more objects, for example a first object 550A and a second object 550B, and the reflected light is detected by one or more of the illumination-detection devices 530. The illumination-detection devices 530 send captured images 531 or other illumination-indicating signals to the one or more material-classification devices 500. In FIG. 5, the materials that compose the objects (e.g., the first object 550A and the second object 550B) are known.

Based on the images 531, the one or more material-classification devices 500 generate a neural-network model 510, which includes generating neural-network-model parameters 515 and hidden-layer units 513. For example, some embodiments extract vectorized patches from the images 531 and use the vectorized patches as visible-layer units of a visible layer to generate the neural-network model 510. Then, based on the hidden-layer units 513, the one or more material-classification devices 500 generate feature-vector representations 501 of the one or more materials that compose the first object 550A and the one or more materials that compose the second object 550B. The feature-vector representations 501 may be generated using, for example, k-means clustering or mixture models (e.g., Gaussian Mixture Models). Also, the feature-vector representations 501 may include the hidden-layer units 513 themselves, for example in embodiments that use patches as visible-layer units, or may include histograms of the hidden-layer units 513, for example in embodiments that use image slices as visible-layer units. Additionally, the feature-vector representations 501 may indicate the pixel intensities of their respective images.

Furthermore, based on the feature-vector representations 501, the one or more material-classification devices 500 generate classifiers 502 for the one or more materials that compose the first object 550A and the one or more materials that compose the second object 550B. Because the materials are known, the one or more material-classification devices 500 store the classifiers 502 and the feature-vector representations 501 in association with their respective materials.

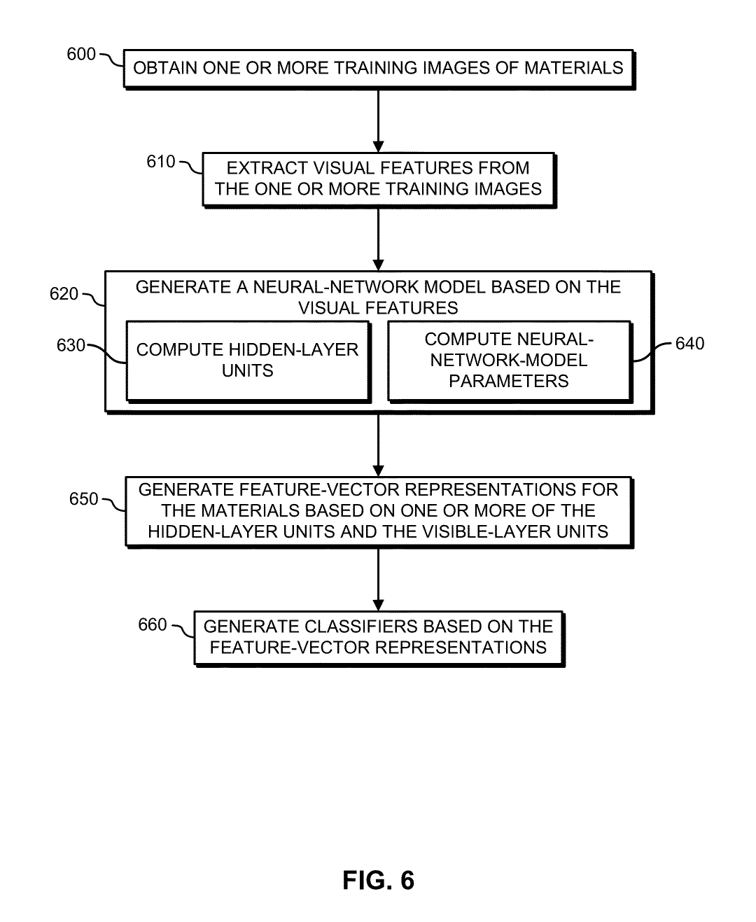

FIG. 6 illustrates an example embodiment of an operational flow for learning and identifying visual features of materials. The flow starts in block 600, where one or more training images of materials are obtained. For example, some embodiments obtain spectral BRDF images of materials from a database. Next, in block 610, visual features are extracted from the one or more training images (e.g., from material samples from the one or more training images). The flow then moves to block 620, where a neural-network model is generated based on the visual features. The operations of block 620 include block 630, where hidden-layer units are computed, and block 640, where neural-network-model parameters are computed. For example, some embodiments extract n×n×w patches from the spectral BRDF images using the low-level features, where n indicates a value in the spatial domain, and w indicates a value in the spectral (e.g., LED number) and angular domain, and then use the n×n×w patches as visible-layer units to generate the neural-network model.

The flow then proceeds to block 650, where feature-vector representations are generated for the materials based on one or more of the hidden-layer units and the visible-layer units. Finally, some embodiments proceed to block 660, where classifiers are generated based on the feature-vector representations.

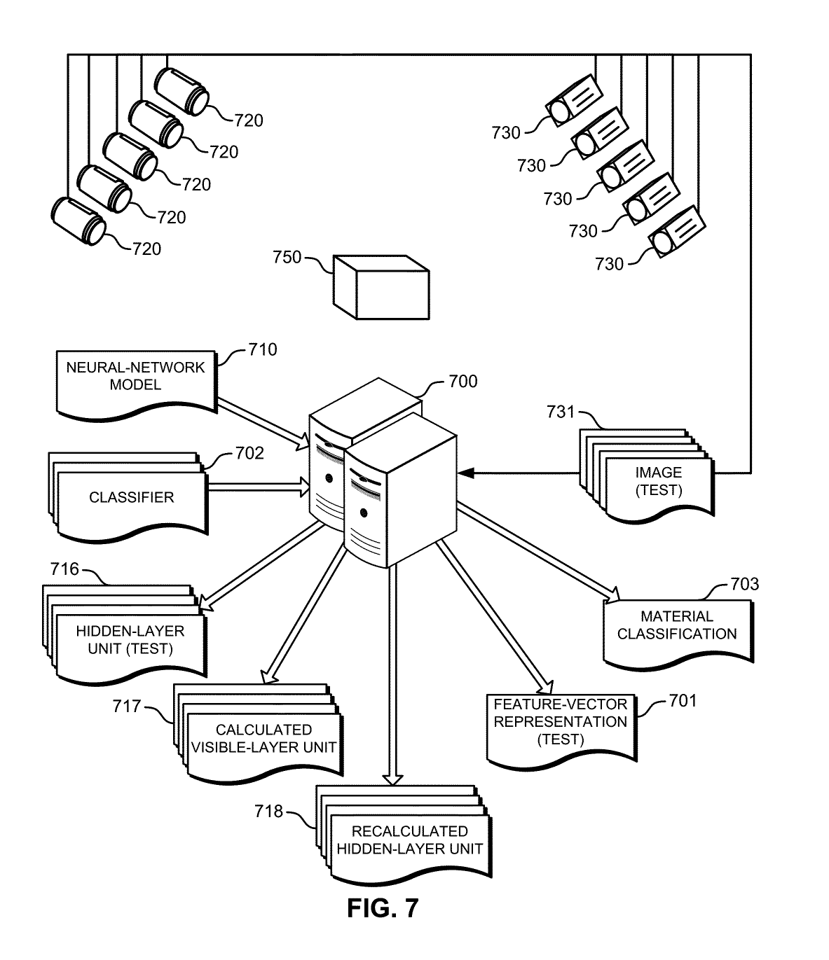

FIG. 7 illustrates an example embodiment of a system for learning and identifying visual features of materials. The system includes one or more material-classification devices 700, one or more illumination-emission devices 720, and one or more illumination-detection devices 730. The illumination-emission devices 720 emit light that is reflected by an object 750, and the reflected light is detected by one or more of the illumination-detection devices 730. The illumination-detection devices 730 send captured images 731 or other illumination-indicating signals to the one or more material-classification devices 700. In FIG. 7, the materials that compose the object 750 are not known.

The one or more material-classification devices 700 obtain a neural-network model 710, which includes neural-network-model parameters and hidden-layer units, and generate test hidden-layer units 716 based on the images 731 and on the neural-network model 710. The one or more material-classification devices 700 then calculate visible-layer units 717 based on the test hidden-layer units 716 and on the neural-network-model parameters. Next, the one or more material-classification devices 700 recalculate hidden-layer units 718 based on the calculated visible-layer units 717 and on the neural-network-model parameters. Also, the one or more material-classification devices 700 generate a feature-vector representation 701 for the object 750 based on the recalculated hidden-layer units 718.

Based on the feature-vector representations 701, the one or more material-classification devices 700 generate a material classification 703 for the object 750. In some embodiments, the one or more material-classification device 700 obtain one or more classifiers 702 and generate the material classification 703 based on the one or more classifiers 702 and the feature-vector representation 701. In some embodiments, the one or more material-classification devices 700 obtain the training feature-vector representations (e.g., the feature-vector representations 501 in FIG. 5) and generate the material classification based on the feature-vector representation 750 of the object and on the training feature-vector representations.

For example, some embodiments use distance-based classification. The distance between each test feature-vector representation 701 and all the training feature-vector representations is computed using the chi-squared distance, which is a distance between histograms. The training feature-vector representations are ranked by order of increasing distance from the test feature-vector representations. Some embodiments classify the material based on the top three feature-vector representations: the material classification 703 is taken to be either that of a material that has multiple feature-vector representations in the top three or, if there is no repetition, the material that has the top-ranked feature-vector representation.

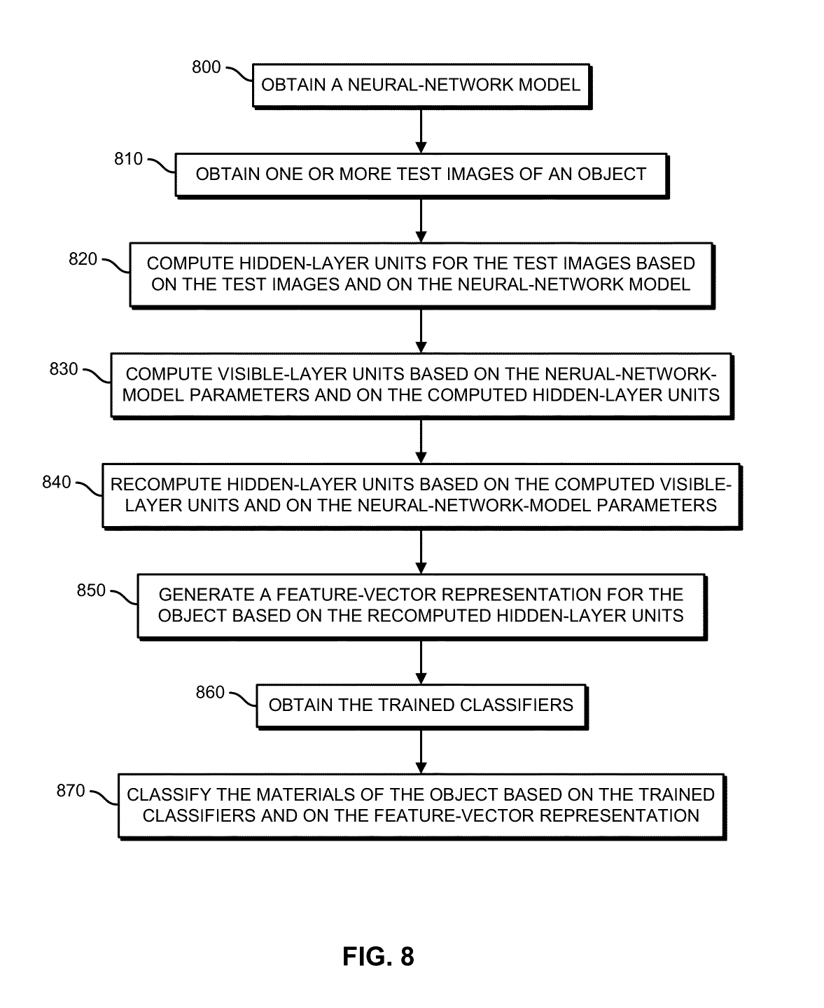

FIG. 8 illustrates an example embodiment of an operational flow for learning and identifying visual features of materials. The flow starts in block 800, where a neural-network model is obtained. Next, in block 810, one or more test images of an object are obtained. The flow then moves to block 820, where hidden-layer units for the test images are computed based on the test images (e.g., on material samples from the test images) and on the neural-network model. The flow then proceeds to block 830, where visible-layer units are computed based on the computed hidden-layer units and on the neural-network-model parameters.

Next, in block 840, recomputed hidden-layer units are generated based on the computed visible-layer units and on the neural-network-model parameters. Then in block 850, a feature-vector representation for the object is generated based on the recomputed hidden-layer units. The flow then moves to block 860, where trained classifiers are obtained. Finally, in block 870, the materials of the object are classified based on the trained classifiers and on the feature-vector representation.

Some embodiments omit block 860 and 870 and generate a material classification based on the feature-vector representation for the object and on obtained feature-vector representations for different materials. Some of these embodiments use distance-based classification (e.g., chi-squared distance) or an SVM (Support Vector Machine) classifier to generate the material classification for the object.

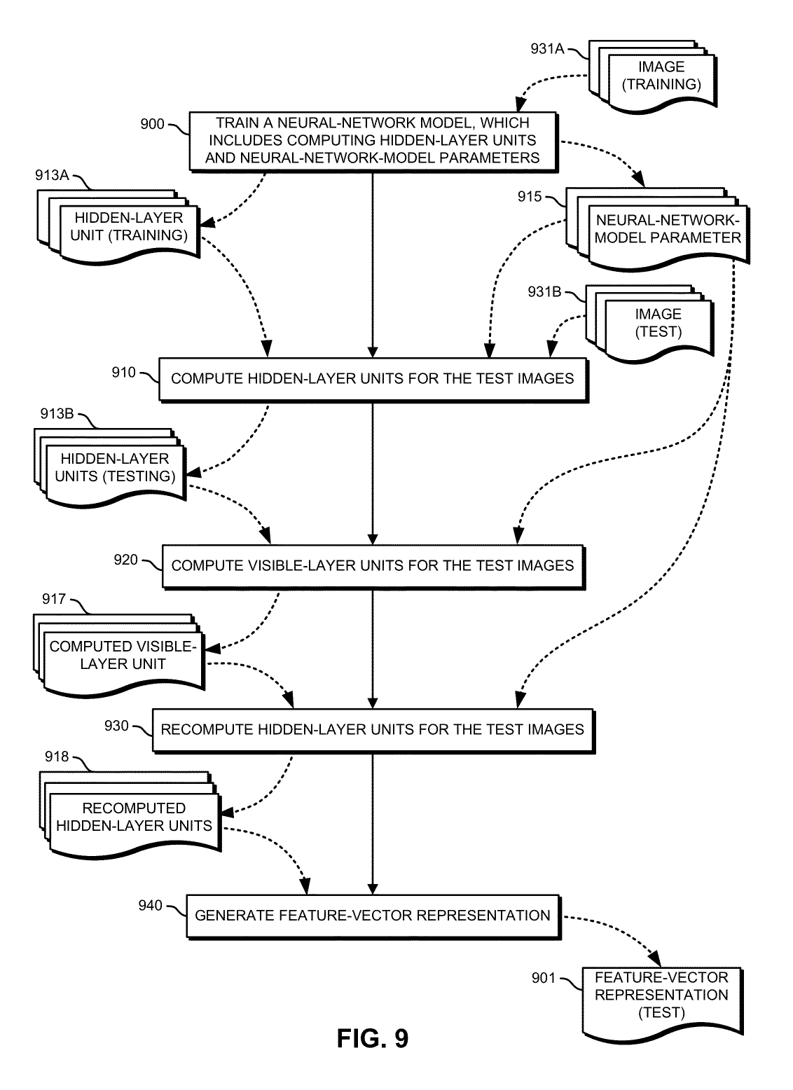

FIG. 9 illustrates an example embodiment of an operational flow for learning and identifying visual features of materials. The flow starts in block 900, where a neural-network model is trained based on training images 931A (e.g., based on material samples from the training images 931A). Training the neural-network model includes computing training hidden-layer units 913A and neural-network-model parameters 915. Next, in block 910, test hidden-layer units 913B are computed based on the test images 931 B and on the neural-network-model parameters 915. Generating the test hidden-layer units 913B includes generating visible-layer units based on the test images 931B (e.g., based on material samples from the test images 931B). The flow then moves to block 920, where visible-layer units 917 for the test images 931B are computed based on the test hidden-layer units 913B. Next, in block 930, hidden-layer units 918 are recomputed for the test images 931B based on the computed visible-layer units 917 and on the previously generated neural-network-model parameters 915. Finally, in block 940, a feature-vector representation 901 is generated based on the computed hidden-layer units 918.

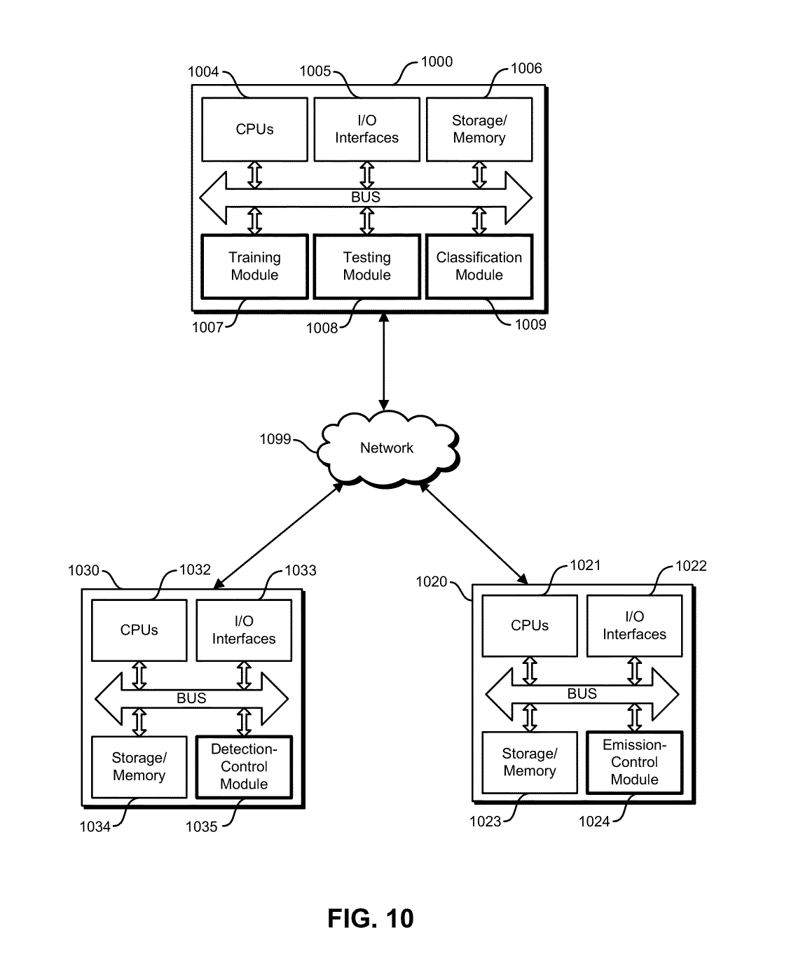

FIG. 10 illustrates an example embodiment of a system for learning and identifying visual features of materials. The system includes a material-classification device 1000, an illumination-emission device 1020, and an illumination-detection device 1030. In this embodiment, the devices communicate by means of one or more networks 1099, which may include a wired network, a wireless network, a LAN, a WAN, and a PAN.

The material-classification device 1000 includes one or more processors (CPUs) 1004, I/O interfaces 1005, and storage/memory 1006. Also, the components of the material-classification device 1000 communicate via a bus. The CPUs 1004 includes one or more central processing units, which include microprocessors (e.g., a single core microprocessor, a multi-core microprocessor) or other circuits, and the CPU 1004 is configured to read and perform computer-executable instructions, such as instructions in storage, in memory, or in a module. The I/O interfaces 1005 include communication interfaces to input and output devices, which may include a keyboard, a display, a mouse, a printing device, a touch screen, a light pen, an optical-storage device, a scanner, a microphone, a camera, a drive, and a network (either wired or wireless).

The storage/memory 1006 includes one or more computer-readable or computer-writable media, for example a computer-readable storage medium. A computer-readable storage medium, in contrast to a mere transitory, propagating signal, includes a tangible article of manufacture, for example a magnetic disk (e.g., a floppy disk, a hard disk), an optical disc (e.g., a CD, a DVD, a Blu-ray), a magneto-optical disk, magnetic tape, and semiconductor memory (e.g., a non-volatile memory card, flash memory, a solid-state drive, SRAM, DRAM, EPROM, EEPROM). The storage/memory 1006 can store computer-readable data or computer-executable instructions.

The material-classification device 1000 also includes a training module 1007, a testing module 1008, and a classification module 1009. A module includes logic, computer-readable data, or computer-executable instructions, and a module may be implemented in software (e.g., Assembly, C, C++, C#, Java, BASIC, Perl, Visual Basic), hardware (e.g., customized circuitry), or a combination of software and hardware. For example, a module may be a self-contained hardware or software component that interfaces with a larger system, a packaged functional hardware unit designed for use with other components, or a part of a program that usually performs a particular function of related functions. In some embodiments, the devices in the system include additional or fewer modules, the modules are combined into fewer modules, or the modules are divided into more modules.

The training module 1007 includes instructions that, when executed, or circuits that, when activated, cause the material-classification device 1000 to obtain one or more training images of one or more materials, extract visual features from the training images, generate a neural-network model based on the visual features, and generate feature-vector representations for the one or more materials based on the neural-network model. Also, in some embodiments, the training module 1007 includes instructions that, when executed, or circuits that, when activated, cause the material-classification device 1000 to train classifiers based on the feature-vector representations.

The testing module 1008 includes instructions that, when executed, or circuits that, when activated, cause the material-classification device 1000 to obtain a neural-network model, obtain one or more test images, compute hidden-layer units for the one or more test images based on the test images and on the neural-network model, compute visible-layer units based on the neural-network model and on the hidden-layer units for the one or more test images, recompute hidden-layer units for the one or more test images based on the computed visible-layer units and on the neural-network model, and generate a feature vector representation for the one or more test images based on the recomputed hidden-layer units.

The classification module 1009 includes instructions that, when executed, or circuits that, when activated, cause the material-classification device 1000 to classify the materials of an object based on the feature-vector representation of the object and the trained feature-vector representations of one or more materials, or to classify the materials of an object based on the feature-vector representation of the object and on trained classifiers of one or more materials.

The illumination-emission device 1020 includes one or more processors (CPUs) 1021, I/O interfaces 1022, storage/memory 1023, an emission-control module 1024, and at least one illumination-emission component (e.g., a laser, an LED light) that is configured to emit illumination. The emission-control module 1024 includes instructions that, when executed, or circuits that, when activated, cause the illumination-emission device 1020 to configure the illumination-emission component according to received illumination-emission-settings values and to activate and deactivate the illumination-emission component, for example according to received emission-timing-setting values.

The illumination-detection device 1030 includes one or more processors (CPUs) 1032, I/O interfaces 1033, storage/memory 1034, a detection-control module 1035, and at least one illumination-detection component (e.g., a CMOS sensor, a CCD sensor) that is configured to detect illumination. The detection-control module 1035 includes instructions that, when executed, or circuits that, when activated, cause the illumination-detection device 1030 to configure the illumination-detection component according to received illumination-detection-settings values and to activate and deactivate the illumination-detection component, for example according to received detection-timing-setting values.

For example, in one embodiment, the system of FIG. 10 generates results for distance-based classification for binary classification tasks. The system uses 25 sets of materials of two types from a database that is provided by the Rochester Institute of Technology (RIT). The 25 sets include 15 sets of only non-ferrous metals and include 10 sets of a combination of both non-ferrous and ferrous metals, which are referred to herein as mixed-metal sets. The sets include the following categories of non-ferrous metals: four types of aluminum, brass, copper, and chromium. The mixed-metal sets additionally include the following categories of ferrous metals: two types of steel and stainless steel. Table 1 shows the sets used in the binary classification experiments.

TABLE 1
The 25 two-category RIT metal sets. The first 15 sets include
only non-ferrous metals, while the remaining 10 sets include
both ferrous metals and non-ferrous metals.
RIT metal sets
considered

Brass/Copper
AL2024/Brass
AL2024/Copper
AL7075/Brass
AL7075/Copper
AL5052/Brass
AL5052/Copper
AL6061/Brass
AL6061/Copper
AL2024/AL5052
AL6061/AL7075
Chromium/Brass
Chromium/Copper
AL7075/Chromium
AL6061/Chromium
Steel1/Steel2
Steel1/Stainless steel
Steel2/Stainless steel
Brass/Stainless steel
Copper/Stainless steel
AL7075/Steel2
Steel1/Chromium
AL7075/Stainless steel
Steel1/Copper
Steel1/Brass

For each material set, the system obtained 4 material samples, for a total of 8 material samples. The system used different combinations or folds of training and test data, such that for each fold the test data contained one material sample from each category. In total, the system used 16 folds of training and testing data, where 75% of the material samples were used for training and 25% were used for testing. Therefore, each fold of a training set had 6 material samples, while a test set had 2 material samples. The classification accuracy was then computed for each set by either (i) taking the average over the accuracies computed for each of the test sets of the 16 folds or (ii) taking the median over the accuracies computed for each of the test sets of the 16 folds.

Table 2 shows classification results over all the 25 sets when the mean and median were calculated over the 25 means and the 25 medians.

TABLE 2
Classification accuracies obtained using distance-based
classification over the RIT metal sets.

| | Mean | Median |
|---|---|---|
| | Accuracy for | Accuracy for |
| Statistic Type | each set (%) | each set (%) |
| Mean | 70 | 80 |
| Median | 75 | 100 |

In one embodiment, a system was designed to assume that there was missing data at test time, although the training data was complete. In this particular embodiment, the system was designed to assume that clusters 6 and 7 in the RIT imaging dome were broken at test time. Therefore the pixel values of the image slices corresponding to these LED clusters were set to 0. The system used the same metal sets that are shown in Table 1 and used the same setup.

The system used the following two types of feature vectors: (i) a 1×150 mean feature vector taken over 150 image slices of an image stack for one material, and (ii) a 1×450 msHOR feature vector. The system also trained an SVM classifier using a training set that included a complete set of images, and the system tested the classifier using test images with missing images. The mean and median classification accuracies taken over the 25 metals sets were lower in the case of missing data in the test images for both types of feature vectors. Table 3 shows the results for the mean classification accuracies when the two types of feature vectors are considered: the mean feature vector computed as the concatenation of the means over the image pixel-intensity values, and the msHOR feature vectors computed as the concatenation of the HOR feature vectors over all 150 image slices.

TABLE 3
Mean classification accuracies obtained using an SVM classifier
with a linear kernel, over all 25 binary sets of metals from the RIT
database, as computed over 16 folds.

| Feature Vector | | |
|---|---|---|
| Type | Complete (%) | Missing (%) |
| Mean_v2 | 76 | 68 |
| msHOR | 81 | 76 |

Table 4 shows the results for the median classification accuracies when the two types of feature vectors were considered: the mean feature vector computed as the concatenation of the means over the image pixel-intensity values, and the msHOR feature vector computed as the concatenation of the HOR feature vectors over all 150 image slices.

TABLE 4
Median classification accuracies obtained using an SVM classifier
with a linear kernel, over all 25 binary sets of metals from the RIT
database, as computed over 16 folds.

| Feature Vector | | |
|---|---|---|
| Type | Complete (%) | Missing (%) |
| Mean_v2 | 77 | 64 |
| msHOR | 83 | 75 |

In one embodiments, a system performed classification using the same training and test data as above, both when the images were complete and when a few images were missing. The feature-vector representations were based on the histograms of hidden-layer units. Table 5 shows the results when the images were missing. Note that these results are identical to the ones in Table 2. This implies that the feature vectors are robust to the missing data phenomenon.

TABLE 5
Classification accuracies obtained using distance-based
classification over the RIT metal sets, when image slices
corresponding to LED clusters 6 and 7 are assumed missing.

| | Mean | Median |
|---|---|---|
| | Accuracy | Accuracy |
| Statistic | for each | for each |
| Type | set (%) | set (%) |
| Mean | 70 | 80 |
| Median | 75 | 100 |

The above-described devices and systems can be implemented, at least in part, by providing one or more computer-readable media that contain computer-executable instructions for realizing the above-described operations to one or more computing devices that are configured to read and execute the computer-executable instructions. The systems or devices perform the operations of the above-described embodiments when executing the computer-executable instructions. Also, an operating system on the one or more systems or devices may implement at least some of the operations of the above-described embodiments.

Any applicable computer-readable medium (e.g., a magnetic disk (including a floppy disk, a hard disk), an optical disc (including a CD, a DVD, a Blu-ray disc), a magneto-optical disk, a magnetic tape, and semiconductor memory (including flash memory, DRAM, SRAM, a solid state drive, EPROM, EEPROM)) can be employed as a computer-readable medium for the computer-executable instructions. The computer-executable instructions may be stored on a computer-readable storage medium that is provided on a function-extension board inserted into a device or on a function-extension unit connected to the device, and a CPU provided on the function-extension board or unit may implement at least some of the operations of the above-described embodiments.

The scope of the claims is not limited to the above-described embodiments and includes various modifications and equivalent arrangements. Also, as used herein, the conjunction “or” generally refers to an inclusive “or,” though “or” may refer to an exclusive “or” if expressly indicated or if the context indicates that the “or” must be an exclusive “or.”

What is claimed is:

1. A method for classifying materials in a scene, the method comprising:
obtaining spectral-BRDF material samples;
learning feature-vector representations for the spectral-BRDF material samples based on the obtained spectral-BRDF material samples;
training classifiers using the learned feature-vector representations; and
generating a material classification using the trained classifiers and a new material sample.

2. The method of claim 1,
wherein learning the feature-vector representations for material samples based on the obtained spectral-BRDF material samples comprises:
forming a first input layer for an artificial neural network based on the spectral-BRDF material samples, wherein the first input layer includes a joint spectral and spatial representation of the spectral-BRDF material samples; and
training the artificial neural network based on the first input layer, wherein training the artificial neural network includes computing parameters of the artificial neural network and computing first hidden-layer units of the artificial neural network.

3. The method of claim 2, wherein learning the feature-vector representations for material samples based on the obtained spectral-BRDF material samples further comprises:
computing second hidden-layer units using the parameters of the artificial neural network and the new material sample as input;
generating reconstructed test data based on the artificial neural network and the second hidden-layer units;
computing third hidden-layer units of the artificial neural network based on the reconstructed test data and the artificial neural network; and
calculating the feature-vector representation of the new material sample based on the third hidden-layer units.

4. The method of claim 3, wherein the artificial neural network is a restricted Boltzmann machine.

5. A system for classifying materials in a scene, the system comprising:
one or more computer-readable media; and
one or more processors that are coupled to the computer-readable media and that are configured to cause the system to
obtain material samples, wherein the material samples include training samples and one or more test samples;
learn feature-vector representations of the training samples based on the obtained training samples; and
generate a material classification based on the feature-vector representations of the training samples and on the one or more test samples.

6. The system of claim 5, wherein, to learn the feature-vector representations of the training samples based on the obtained training samples, the one or more processors are further configured to cause the system to
generate first visible-layer units based on the training samples;
train an artificial neural network based on the first visible-layer units, wherein the artificial neural network includes parameters and first hidden-layer units that were generated based on the first visible-layer units; and
generate the feature-vector representations of the training samples based on the first hidden-layer units.

7. The system of claim 6, wherein, to generate the material classification based on the feature-vector representations of the training samples and on the one or more test samples, the one or more processors are further configured to cause the system to
generate second visible-layer units based on the test samples,
generate second hidden-layer units based on the artificial neural network and on the second visible-layer units,
generate third visible-layer units based on the second hidden-layer units and on the parameters,
generate third hidden-layer units based on the second visible-layer units and on the parameters,
generate a feature-vector representation of the one or more test samples based on the third hidden-layer units, and
generate the material classification based on the feature-vector representations of the training samples and on the feature-vector representation of the one or more test samples.

8. The system of claim 7, wherein the feature-vector representations include the third hidden-layer units.

9. The system of claim 7, wherein, to generate the feature-vector representations of the training samples based on the first hidden-layer units, the one or more processors are further configured to cause the system to generate respective histograms of the first hidden-layer units for the training samples, and
wherein, to generate the feature-vector representation of the one or more test samples based on the third hidden-layer units, the one or more processors are further configured to cause the system to generate respective histograms of the third hidden-layer units for the one or more test samples.

10. The system of claim 9, wherein the one or more processors are further configured to cause the system to train one or more classifiers using the respective histograms of the first hidden-layer units, and
wherein, to generate the material classification based on the feature-vector representations of the training samples and on the feature-vector representation of the one or more test samples, the one or more processors are further configured to cause the system to classify the one or more test samples using the one or more histograms of the third hidden-layer units and on the one or more classifiers.

11. The system of claim 9, wherein, to generate the material classification based on the feature-vector representations of the training samples and on the feature-vector representation of the one or more test samples, the one or more processors are further configured to cause the system to calculate a distance between the one or more histograms of the third hidden-layer units for the one or more test samples and the respective histograms of the first hidden-layer units for the training samples.

12. The system of claim 5, wherein the samples are image slices or image patches.

13. One or more computer-readable media storing instructions that, when executed by one or more computing devices, cause the computing devices to perform operations comprising:
obtaining material samples, wherein the material samples include training samples and one or more test samples;
learning feature-vector representations of the training samples based on the obtained training samples; and
generating a material classification based on the feature-vector representations of the training samples and on the one or more test samples.

14. The one or more computer-readable media of claim 13, wherein learning the feature-vector representations of the training samples based on the obtained training samples includes
generating first visible-layer units based on the training samples;
training an artificial neural network based on the first visible-layer units, wherein the artificial neural network includes parameters and first hidden-layer units that were generated based on the first visible-layer units; and
generating the feature-vector representations of the training samples based on the first hidden-layer units.

15. The one or more computer-readable media of claim 14, wherein generating the material classification based on the feature-vector representations of the training samples and on the one or more test samples includes
generating second visible-layer units based on the test samples,
generating second hidden-layer units based on the artificial neural network and on the second visible-layer units,
generating third visible-layer units based on the second hidden-layer units and on the parameters,
generating third hidden-layer units based on the second visible-layer units and on the parameters,
generating a feature-vector representation of the one or more test samples based on the third hidden-layer units, and
generating the material classification based on the feature-vector representations of the training samples and on the feature-vector representation of the one or more test samples.

16. The one or more computer-readable media of claim 15, wherein generating the material classification based on the feature-vector representations of the training samples and on the feature-vector representation of the one or more test samples includes
calculating a distance between the feature-vector representations of the training samples and the feature-vector representation of the one or more test samples.

17. The one or more computer-readable media of claim 15, wherein generating the material classification based on the feature-vector representations of the training samples and on the feature-vector representation of the one or more test samples includes
training one or more classifiers based on the feature-vector representations of the training samples, and
generating the material classification based on the one or more classifiers and on the feature-vector representation of the one or more test samples.

18. The one or more computer-readable media of claim 13, wherein a material sample is an image stack.

19. The one or more computer-readable media of claim 13, wherein a material sample is an image slice.

20. The one or more computer-readable media of claim 13, wherein a material sample is an image patch.
